(19) United States
(12) Patent Application Publication
(10) Pub. No.: US 2014/0254858 A1
(43) Pub. Date: Sep. 11, 2014

(54) Electro-acoustic transducer

(71) Applicant: Jing He, Shenzhen (CN)

(72) Inventor: Jing He, Shenzhen (CN)

(73) Assignee: AAC TECHNOLOGIES PTE. LTD.,, Singapore city (SG)

(21) Appl. No.: 14/195,015

(22) Filed: Mar. 3, 2014

(30) Foreign Application Priority Data
Mar. 5, 2013 (CN) 201320099161.1

(51) Int. Cl. H04R 1/02

(52) U.S. Cl. CPC H04R 1/02
USPC 381/398

(57) ABSTRACT

An electro-acoustic transducer includes a frame having sidewalls, a magnetic circuit system received in the frame and a vibration system fixed to the frame. The vibration system includes a vibrating diaphragm and a driving voice coil for driving the vibrating diaphragm to move. The electro-acoustic transducer further includes a communication coil, which is fixed within the frame and located below the vibrating diaphragm and surrounding the driving voice coil. The communication coil is a symmetric loop structure, which includes four straight edge portions and curved corner portions located at four corners to connect adjacent straight edge portions. A distance between each of the curved corner portions and the driving voice coil is greater than a distance between each of the straight edge portions and the driving voice coil.

### FIELD OF THE INVENTION

The present disclosure relates to an electro-acoustic transducer, and more particularly, to an electro-acoustic transducer with a communication function.

### BACKGROUND OF THE INVENTION

With development of the market of portable consumer electronic products, electro-acoustic transducers, especially those having a hearing aid function or a communication function (e.g., near field communication) have been widely used.

To achieve the communication function, existing electro-acoustic transducers with the communication function are usually provided with communication voice coils. The communication voice coil used in the existing electro-acoustic transducers is usually a symmetric loop structure located below the vibrating diaphragm and surrounding a driving voice coil. The communication voice coil comprises four straight edge portions and curved corner portions jointing adjacent two straight edge portions. The conventional communication voice coil is spaced from the driving coil at an equal distance. During operation of the electro-acoustic transducer, the driving voice coil drives the diaphragm to vibrate. However, the corner portions tend to contact with the diaphragm, which causes noises and degrades the reliability of the device. On the other hand, if the distance between the communication voice coil and the driving voice coil is designed to be increased to solve this problem, the dimensions of the electro-acoustic transducer is increased, and the communication effect will be affected.

Accordingly, there is a need to provide an electro-acoustic transducer with a communication function that can improve the product reliability and solve the aforesaid shortcomings.

### BRIEF DESCRIPTION OF THE DRAWINGS

FIG. 1 is an exploded isometric view of an electro-acoustic transducer according to an exemplary embodiment of the present disclosure.

FIG. 2 is a cross-sectional view of the electro-acoustic transducer in FIG. 1.

FIG. 3 is a partial assembled schematic view of the electro-acoustic transducer in FIG. 1.

### DETAILED DESCRIPTION OF THE INVENTION

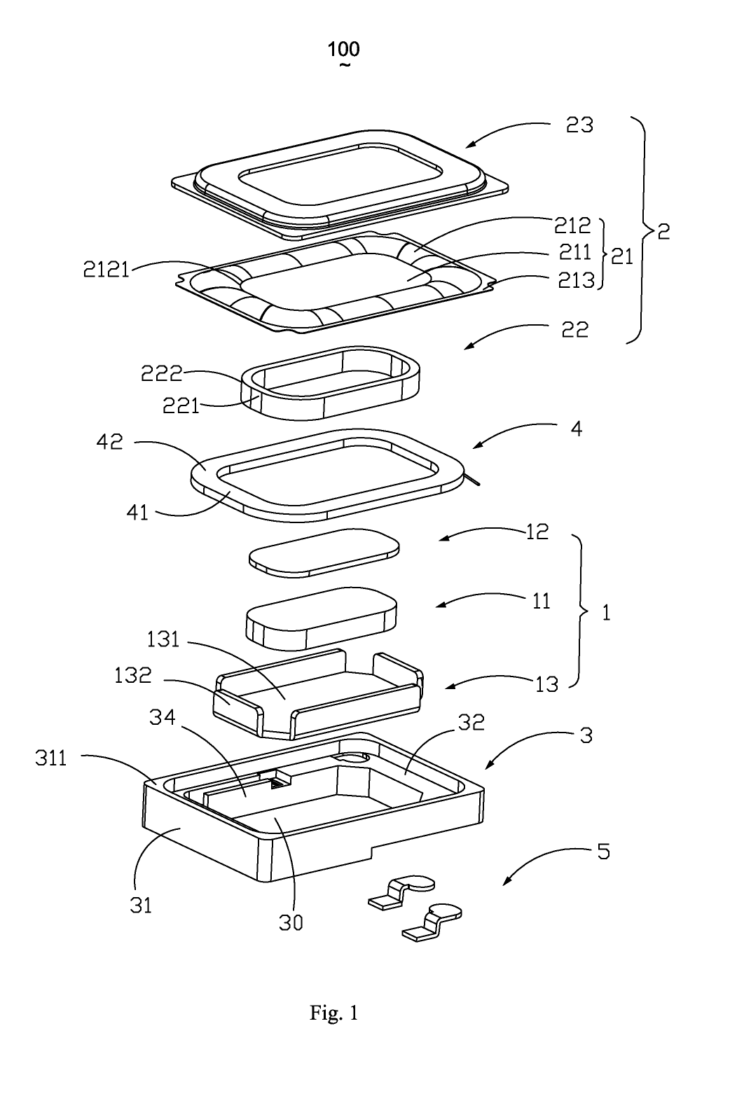

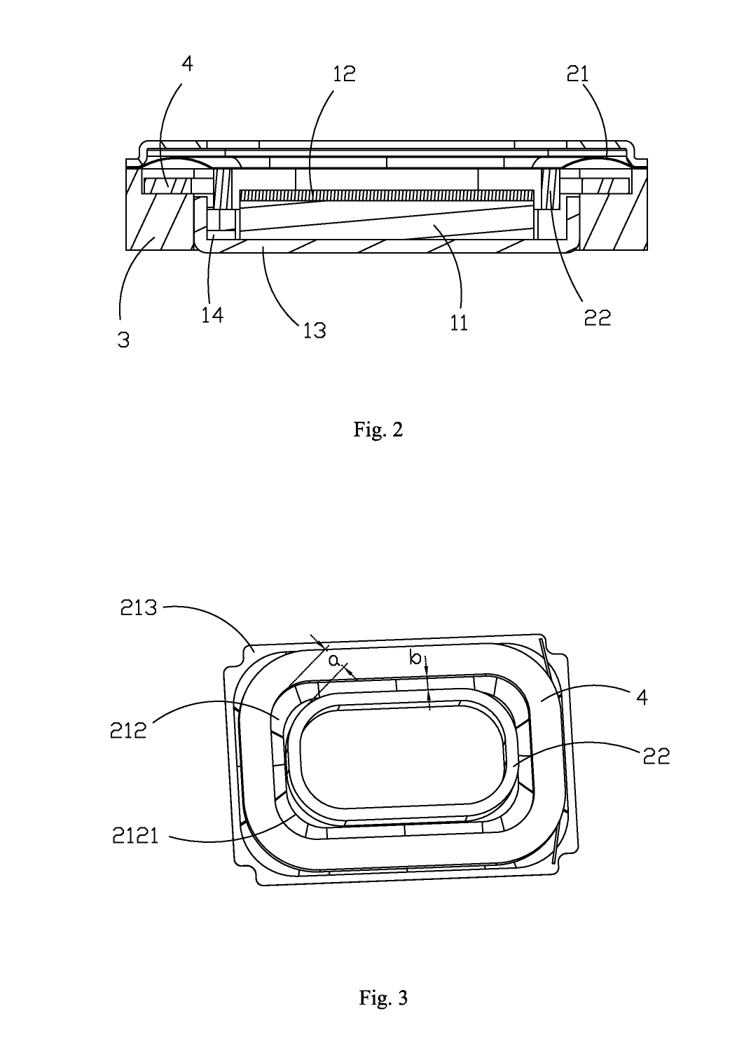

Referring to FIGS. 1-2, the electro-acoustic transducer 100 with a communication function comprises a magnetic circuit system 1, a vibration system 2, a frame 3 having a receiving portion 30, and a communication coil 4.

The magnetic circuit system 1 is received in the receiving portion 30 of the frame 3 correspondingly. The vibration system 2 is fixed on the frame 3. The communication coil 4 is also fixed on the frame 3 and is disposed to surround the magnetic circuit system 1.

The magnetic circuit system 1 comprises a magnet 11, a pole plate 12 and a yoke 13. The magnet 11 is fixed on an upper surface of the yoke 13. The pole plate 12 is attached on a surface of the magnet 11. It should be noted that, the yoke 13 in this may have a bowl-like shape and may also have a flat-plate structure or may be a combination of a flat plate with side plates extending from the flat plate, as long as the yoke includes a bottom plate for placing the magnet 11 thereon.

In this embodiment, the yoke 13 comprises a body portion 131 and side plates 132 that are bent and extend from the body 131. The steel magnet 11 is stacked at a central position of the body 131. The body 131 and the side plates 132 are all permeability magnetic materials, which can ensure a uniform distribution of the magnetic field. The outer profile of the steel magnetic 11 is smaller than the profile of the body 131. A magnetic gap 14 is formed in the magnetic circuit system 1. In an alternative embodiment, the magnetic circuit system 1 may include a plurality of magnets. Magnetic gap may be formed between two adjacent magnets.

The vibration system 2 comprises a vibrating diaphragm 21 and a driving voice coil 22 for driving the vibrating diaphragm 21 to vibrate. The vibrating diaphragm 21 comprises a dome 211 located in a central portion thereof, a suspension 212 surrounding the dome 211 and a connecting portion 213 connected with the suspension 212.

In this embodiment, the dome 211 is a flat-plate structure and connects with the driving voice coil 22. Of course, in alternative embodiments, the dome 211 may also be some other structure (e.g., an arch), and the dome 211 may also be integral with the suspension 212. The vibrating diaphragm 21 may be further provided with a vibrating plate (not shown) thereon, which covers the dome 211 and functions to enhance the vibration of the vibrating diaphragm. In this embodiment, the vibration system 2 further comprises a front cap 23, which covers the vibrating diaphragm 21. The front cap 23 comprises a sound hole 231 therethrough. An end of the driving voice coil 22 is suspended in the magnetic gap 14.

The frame 3 comprises a plurality of sidewalls 31 for forming the receiving portion 30. The sidewall 31 comprises an upper surface 311, a lower surface (which is not indicated by a reference numeral) opposite to the upper surface 311 and an inner surface 34. The sidewall 31 is provided with a stepped portion 32 extending in a direction toward the lower surface from the upper surface 311 on the inner surface 34. The connecting portion 213 of the vibrating diaphragm 21 is fixed on the upper surface 311 of the sidewall 31. The yoke 13 is received in the receiving portion 30 correspondingly. The side plates 132 abut against the inner surface 34 respectively to fix the yoke 13.

The communication coil 4 may be a hearing aid voice coil or some other communication coil (e.g., an NFC communication coil). In this implementation, the communication coil is a hearing aid voice coil, which provides the electro-acoustic transducer with a hearing aid function. The communication coil 4 is disposed on the stepped portion 32.

Referring to FIGS. 1 and 3, the communication coil 4 is a symmetric loop structure, which includes four straight edge portions 41 and curved corner portions 42 located at four corners to connect adjacent straight edge portions 41. The driving voice coil 22 includes four straight portions 221 and curved portions 222 located at four corners to connect adjacent straight portions 221. The straight edge portions 41 of the communication coil 4 correspond to the straight portions 221 of the driving voice coil 22. The curved corner portions 42 of the communication coil 4 correspond to the curved portions 222 of the driving voice coil 22. The communication coil 4 surrounds the driving voice coil 22. Inner edges of respective straight edge portions 41 of the communication coil 4 have a same distance from outer edges of respective straight portions 221 of the driving voice coil 22. A distance between an inner edge of the curved corner portion 42 of the communication coil 4 and an outer edge of the corresponding curved portion 222 of the driving voice coil 22 is greater that between an inner edge of the straight edge portion 41 of the communication coil 4 and an outer edge of the corresponding straight portion 221 of the driving voice coil 22. That is, as shown in FIG. 3, the distance a between the inner edge of the curved corner portion 42 is greater than the distance between the inner edge of the straight edge portion 41 and the outer edge of the straight portion 221. A curvature of the curved corner portions 42 of the communication coil 4 is greater than a curvature of the curved portions 222 of the driving voice coil 22. As such, each of the curved corner portions 42 can keep an enough distance from the driving voice coil 22, which prevents the curved corner portions 42 and the vibrating diaphragm 21 from contacting and interfering with each other. Meanwhile, the distance set between each of the straight edge portions 41 and the driving voice coil 22 is not affected, and the communication effect of the communication coil 4 is ensured.

In this embodiment, the electro-acoustic transducer 100 further includes a conductive terminal 5 fixed with the frame 3. The conductive terminal 5 has one end thereof connected with the driving voice coil 22 and the communication coil 4 and the other end connected to an external power source. In this embodiment, the driving voice coil 22 and the communication coil 4 connect with the same conductive terminal and connect with the external power source through the conductive terminal. In alternative embodiments, the number of the conductive terminals may be more than one, and the driving voice coil 22 and the communication coil 4 may connect with the external power source separately.

In the electro-acoustic transducer 100 of the present disclosure, the distance between each of the curved corner portions of the hearing aid voice coil and the driving voice coil is greater than the distance between each of the straight edge portions of the hearing aid voice coil and the driving voice coil, which can effectively prevent the curved corner portions and the vibrating diaphragm from contacting and interfering with each other, so that the reliability of the electro-acoustic transducer is improved.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. An electro-acoustic transducer, comprising:
a frame having a receiving portion,
a magnetic circuit system received in the receiving portion correspondingly,
a vibration system fixed to the frame, comprising a vibrating diaphragm and a driving voice coil for driving the vibrating diaphragm,
a communication coil surrounding the driving voice coil, the communication coil comprising a plurality of straight edge portions and curved corner portions for connecting adjacent straight edge portions,
wherein the driving voice coil comprises a plurality of straight portions and curved portions for connecting adjacent straight portions, the straight portions of the driving voice coil correspond to the straight edge portions of the communication voice coil, the curved portions of the driving voice coil correspond to the curved corner portions of the communication voice coil;
wherein a distance between an inner edge of the curved corner portion of the communication coil and an outer edge of the corresponding curved portion of the driving voice coil is greater that between an inner edge of the straight edge portion of the communication coil and an outer edge of the corresponding straight portion of the driving voice coil.

2. The electro-acoustic transducer of claim 1, wherein a curvature of the curved corner portions of the communication voice coil is greater than a curvature of the curved portions.

4. The electro-acoustic transducer of claim 1, wherein the communication coil is a hearing aid voice coil or near field communication coil.

5. An electro-acoustic transducer, comprising:
a frame having a receiving portion,
a magnetic circuit system, being received in the receiving portion correspondingly,
a vibration system fixed to the frame, comprising a vibrating diaphragm and a driving voice coil for driving the vibrating diaphragm to move, and the driving voice coil comprising a plurality of curved portions,
a communication coil surrounding the driving voice coil, the communication coil comprising a plurality of curved corner portions corresponding to the curved portions, wherein a curvature of the curved corner portions is greater than a curvature of the curved portions.

6. The electro-acoustic transducer of claim 5, wherein the communication voice coil comprises a plurality of straight edge portions, and the curved corner portions connect adjacent straight edge portions, and wherein the driving voice coil comprises a plurality of straight portions, the curved portions connect adjacent straight portions, and the straight edge portions of the communication coil correspond to the straight portions of the driving voice coil.

7. The electro-acoustic transducer of claim 5, wherein the frame comprises a sidewall that encloses the receiving portion, a stepped portion is formed on an inner side surface of the sidewall, and the communication coil is disposed on the stepped portion.

8. The electro-acoustic transducer of claim 5, wherein the sidewall comprises an upper surface and a lower surface opposite to each other, and the vibrating diaphragm comprises a connecting portion fixed to the upper surface of the sidewall.

9. The electro-acoustic transducer of claim 8, wherein the sidewall further comprises an inner surface that connects the upper surface and the lower surface, the inner surface forms an outer profile of the receiving portion, the magnetic circuit system comprises a yoke, the yoke comprises a body and a side plate extending from the body, and the side plate abuts against the inner surface of the sidewall of the frame.
